(19) United States
(12) Patent Application Publication
(10) Pub. No.: US 2018/0223878 A1
(43) Pub. Date: Aug. 9, 2018

(54) HYDRAULIC ACTUATOR, PARTICULARLY OF THE SHOCK ABSORBING AND/OR DAMPING TYPE

(71) Applicant: ANTONIONI HYDRAULIC SOLUTIONS S.R.L., Monterchi (IT)

(72) Inventor: Angelo ANTONIONI, Monterchi (IT)

(21) Appl. No.: 15/749,848

(22) PCT Filed: Aug. 1, 2016
(86) PCT No.: PCT/EP2016/068316

§ 371 Date: Feb. 2, 2018

(30) Foreign Application Priority Data
Aug. 4, 2015 (IT) 102015000041592

(51) Int. Cl. F15B 1/02; F16F 15/023; F15B 15/14; F15B 20/00

(52) U.S. Cl. CPC F15B 1/021; F16F 15/023; F15B 15/24; F15B 15/1447; F15B 20/007; F15B 15/1457

(57) ABSTRACT

A hydraulic actuator includes a piston accommodated to slide hermetically in a hollow cylinder to divide the internal volume of the hollow cylinder into two chambers. The hydraulic actuator includes a first movable element accommodated so that it can slide hermetically in a longitudinal cavity defined inside the piston stem to divide the longitudinal cavity into two portions with the first one connected to one of the two chambers and the second one connectable to a second circuit adapted to feed under pressure a second fluid into the second portion. The second fluid has a coefficient of compressibility and a nominal pressure greater than those of the first fluid to act as a shock absorber and/or damper in case of sudden peaks of pressure in the chamber connected to the first portion of the longitudinal cavity defined inside the piston stem.

### TECHNICAL FIELD

The present disclosure relates to a hydraulic actuator, particularly of the shock absorbing type.

### BACKGROUND

In the field of lifting devices and, more generally, in the field of devices for handling large loads, it is known to use hydraulic jacks or actuators which, thanks to the action of a pressurized liquid, usually hydraulic oil, on a piston that operates within a cylinder to which the load is connected, allow to generate considerable forces.

The pressurized liquid is usually sent from an external circuit that regulates its inflow into the cylinder so as to vary its direction of motion and its speed.

Since the pressurized liquid is incompressible, the actuator is unable to dissipate the impacts to which it is subjected, both if they are due to pressure peaks of the delivery liquid due to the inertias of the entire system, a phenomenon known commonly as hammer, and if they are due to sudden increases in the load applied to such actuator.

In view of the above, the background art connects the external circuit to an accumulator that contains pressurized gas at a nominal pressure that is higher than the nominal operating pressure of the pressurized liquid.

In this manner, every time the pressurized liquid is subjected to an overpressure that is higher than the pressure value of the gas, such gas begins to compress, protecting and absorbing any pressure peaks by transferring volume to the circuit.

These actuators of the known type, which are used widely for example in earth-moving machines and agricultural and industrial lifting machines, are not devoid of drawbacks, which include the fact that the actuators, used to obviate the pressure peaks described earlier, are installed externally to the actuator proper, since they are connected to the feed circuit of the actuator or to the actuator proper, being an element of hindrance to the normal movement of the actuator or in any case requiring space that is not available in the points where they are installed.

Accordingly, said accumulators are installed by means of a plurality of connecting elements, such as for example pipes and valves, which limit their effectiveness due to flow-rate losses.

Another drawback of actuators of the known type, provided with external accumulators, resides in that they do not allow to install said accumulators safely.

If the accumulator is installed before the safety valve, with which actuators assigned to lifting loads safely must be equipped and which is adapted to control the flow of the oil both in input and an output from the actuator, if the connections of the ducts or of the accumulator proper fail, the load carried by the pressure of the circuit is in fact in free fall, since the oil has an escape path where to flow, rendering the function of the safety valve useless.

Otherwise, if the accumulator is installed after the safety valve, the accumulator is excluded from its function and is useless.

### SUMMARY

The aim of the present disclosure is to provide a hydraulic actuator that obviates the drawbacks noted above, overcoming the limitations of the background art while complying with the corresponding safety standards for the means on which it can be applied both on the road and off-road.

Within this aim, the present disclosure provides a hydraulic actuator the operation of which can be adjusted so that it is possible to vary its effectiveness according to the desired effect, modifying the operating pressure inside the actuator.

The present disclosure also provides a hydraulic actuator that is extremely simple in terms of construction and use and therefore has low manufacturing and maintenance costs.

This aim, as well as these and other advantages that will become better apparent hereinafter, are achieved by providing a hydraulic actuator, particularly of the shock absorbing and/or damping type, comprising a piston that is accommodated so that it can slide hermetically in a hollow cylinder so as to divide the internal volume of said hollow cylinder into two chambers mutually separated by the head of said piston, said two chambers being connectable separately, respectively by means of at least one delivery duct and at least one discharge duct, to a first circuit adapted to feed under pressure a first fluid into one of said two chambers with consequent emptying of the other of said two chambers for the extension or compression movement of said piston with respect to said hollow cylinder, characterized in that it comprises a first movable element that is accommodated so that it can slide hermetically in a longitudinal cavity defined inside the stem of said piston so as to divide said longitudinal cavity into two portions with the first of said two portions connected to one of said two chambers and with the second of said two portions connectable to a second circuit adapted to feed under pressure a second fluid into said second portion, said second fluid having a coefficient of compressibility and a nominal pressure greater than those of said first fluid so as to act as a shock absorber and/or damper in case of sudden peaks of pressure in said chamber connected to said first portion of said longitudinal cavity defined inside said stem of said piston.

### BRIEF DESCRIPTION OF THE DRAWINGS

Further characteristics and advantages of the disclosure will become better apparent from the description of two preferred but not exclusive embodiments of a hydraulic actuator, particularly of the shock absorbing and/or damping type, according to the disclosure, illustrated by way of non limiting example in the accompanying drawings, wherein:

FIGS. 1 to 3 are three sectional views of a first embodiment of an actuator that acts by extension, according to the disclosure in the various active steps of its operation;

FIGS. 4 to 6 are three sectional views of the actuator shown in the preceding figures, acting to protect the extension, according to the disclosure in the various active steps of its operation;

FIGS. 7 to 9 are three sectional views of a second embodiment of an actuator that acts by compression, according to the disclosure in the various active steps of its operation;

FIGS. 10 to 12 are three sectional views of the actuator shown in FIGS. 7 to 9, acting to protect compression, according to the disclosure in the various active steps of its operation;

FIGS. 13 and 14 are two sectional views of a first variation of the actuators shown in the preceding figures;

FIGS. 15 and 16 are two sectional views of a second variation of the actuators shown in FIGS. 1 to 12;

FIG. 17 is a side elevation view of a safety valve applied to the actuators shown in FIGS. 1 to 12;

FIG. 18 is a sectional view of the safety valve shown in FIG. 17, taken along the sectional line XVIII-XVIII in its inactive state;

FIG. 19 is a sectional view of the safety valve shown in FIG. 17, taken along the sectional line XVIII-XVIII in a first active state thereof, and

FIG. 20 is a sectional view of the safety valve shown in FIG. 17, taken along the sectional line XVIII-XVIII in a first active state thereof.

### DETAILED DESCRIPTION OF THE DRAWINGS

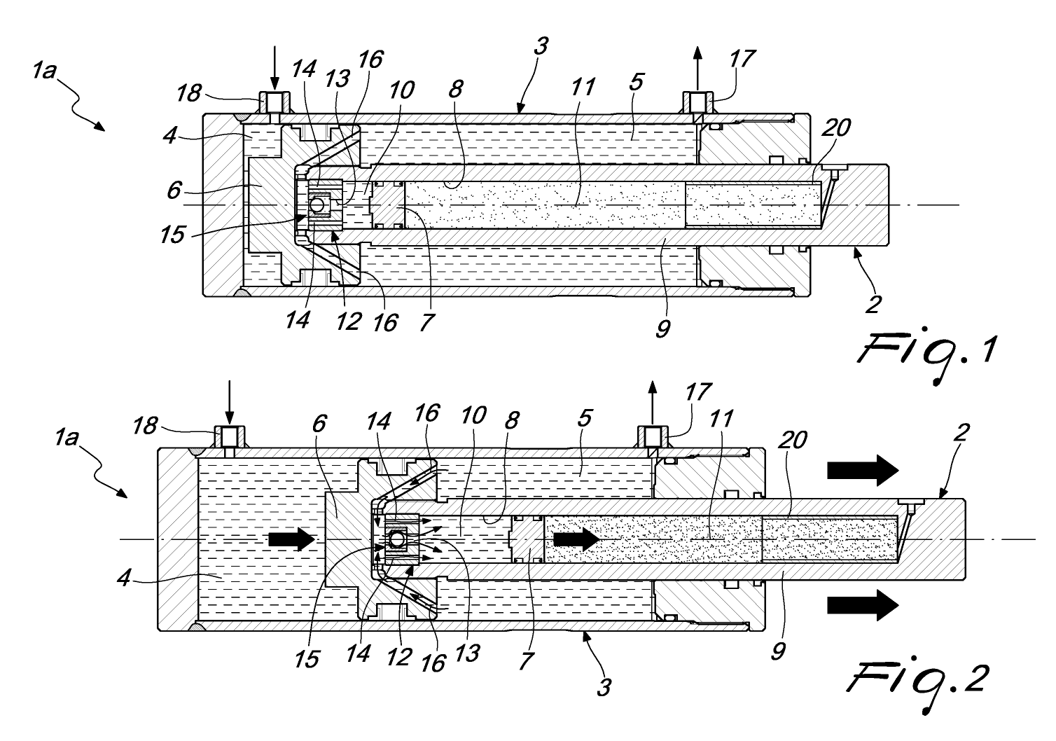

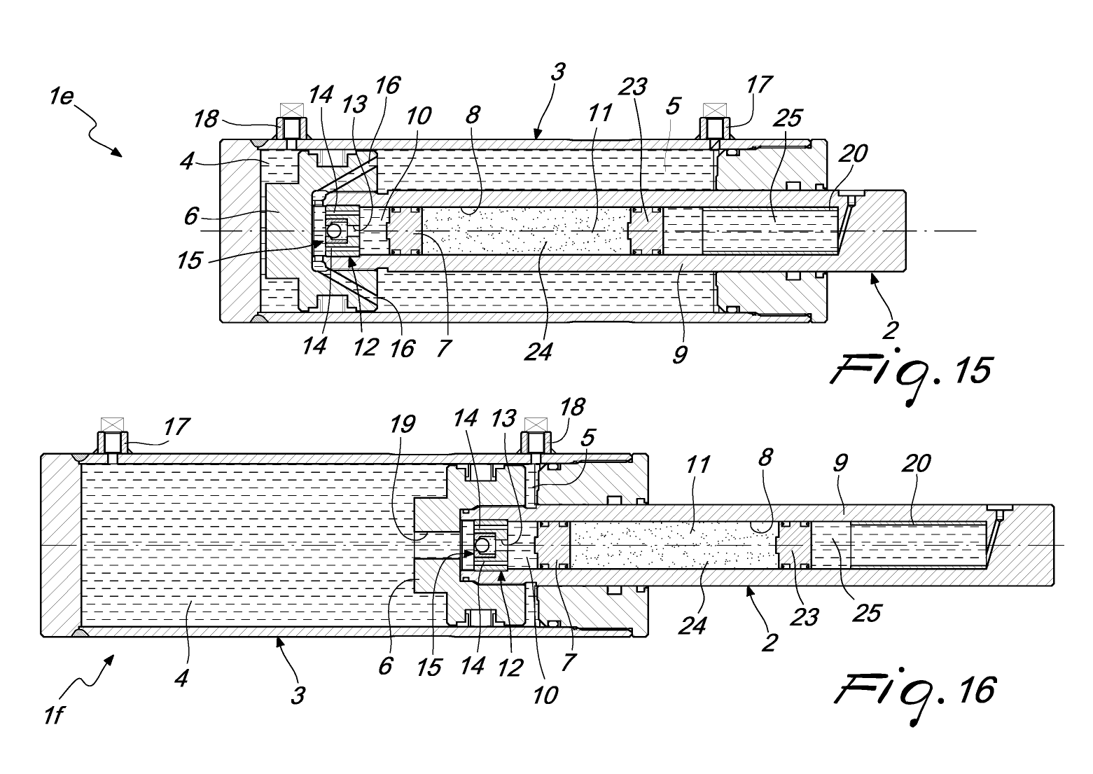

With reference to FIGS. 1-20, the hydraulic actuator, particularly of the shock absorbing and/or damping type, generally designated in the two proposed embodiments by the reference numerals 1a and 1b, comprises a piston 2, which is accommodated slidingly and hermetically in a hollow cylinder 3 so as to divide the internal volume of the latter into two chambers 4 and 5 that are mutually separated by the head 6 of the piston 2.

In greater detail, depending on the embodiment considered, the two chambers 4 and 5 can be connected separately, respectively by means of at least one delivery duct 17 and at least one discharge duct 18, to a first circuit that is adapted to introduce under pressure a first fluid, for example oil, in one of the two chambers 4 or 5, with consequent emptying of the other chamber 5 or 4 for the extension or compression motion of the piston 2 with respect to the hollow cylinder 3.

According to the disclosure, a first movable element 7 is provided, which is accommodated so that it can slide hermetically in a longitudinal cavity 8 that is defined inside the stem 9 of the piston 2 so as to divide the longitudinal cavity 8 into two portions 10 and 11, the first of which is connected to one of the two chambers 4 and 5, depending on the embodiment considered, and the second of which can be connected to a second circuit that is adapted to introduce under pressure a second fluid, for example gas, in the second portion 11.

Advantageously, as will be described better hereinafter, the second fluid cited above has a coefficient of compressibility, i.e., the ability to be compressed for an equal pressure, and a nominal pressure that are greater than those of the first fluid, so as to act as a shock absorber and/or damper in case of sudden pressure peaks in the chamber 4 or 5 that is connected to the first portion 10 of the longitudinal cavity 8 defined inside the stem 9 of the piston 2.

Conveniently, there are also fluid flow control means 12 interposed between the first portion 10 and the chamber 4 or 5 that is connected to the first portion 10.

More specifically, the fluid flow control means 12 define a main connecting channel 13 and one or more secondary connecting channels 14 with the main connecting channel 13 having a passage section that has a larger diameter than the passage section offered by the secondary connecting channels 14.

Advantageously, the main connecting channel 13 is provided with a normally-closed one-way valve 15, for example of the type with a ball that can move in contrast with the action of elastic means, differently from the secondary connecting channels 14, which are free from obstructions.

In this manner, as will be described better hereinafter, the first fluid can flow out easily and quickly from the chamber 4 or 5 to the first portion 10 of the longitudinal cavity 8 both through the secondary connecting channels 14 and through the main connecting channel 13, which is open by way of the opening of the one-way valve 15, and can flow out in the opposite direction only through the secondary connecting channels 14, since the main connecting channel 13 is closed, thus entailing an outflow rate that is very low with respect to the one when the one-way valve 15 is open.

Operation of the hydraulic actuators 1a and 1b is described hereinafter.

With reference to FIGS. 1 to 3, a hydraulic actuator 1a that acts by extension is shown in the first proposed embodiment.

Starting from a position in which the piston 2 is completely retracted into the hollow cylinder 3, shown in FIG. 1, the external circuit for delivery of the first fluid feeds the chamber 4, emptying the chamber 5 in order to make the piston 2 exit.

Due to the inertias of the system, in this initial transient situation a pressure peak can occur which is such that the pressure of the first fluid exceeds its nominal value, leading to the phenomenon commonly known as hammer.

If this overpressure is such as to exceed also the value of the nominal pressure of the second fluid contained in the second portion 11 of the longitudinal cavity 8 provided internally in the stem 9 of the piston 2, the one-way valve 15 opens, making the first fluid flow out rapidly inside the first portion 10 of the longitudinal cavity 8, with a corresponding displacement of the first movable element 7 and a consequent compression of the second fluid, as shown in FIG. 2.

This flow of the first fluid from the chamber 5 inside the first portion 10, which occurs by means of one or more ducts 16 defined inside the head 6 of the piston 2, continues until a new condition of equilibrium between the two fluids has been reached.

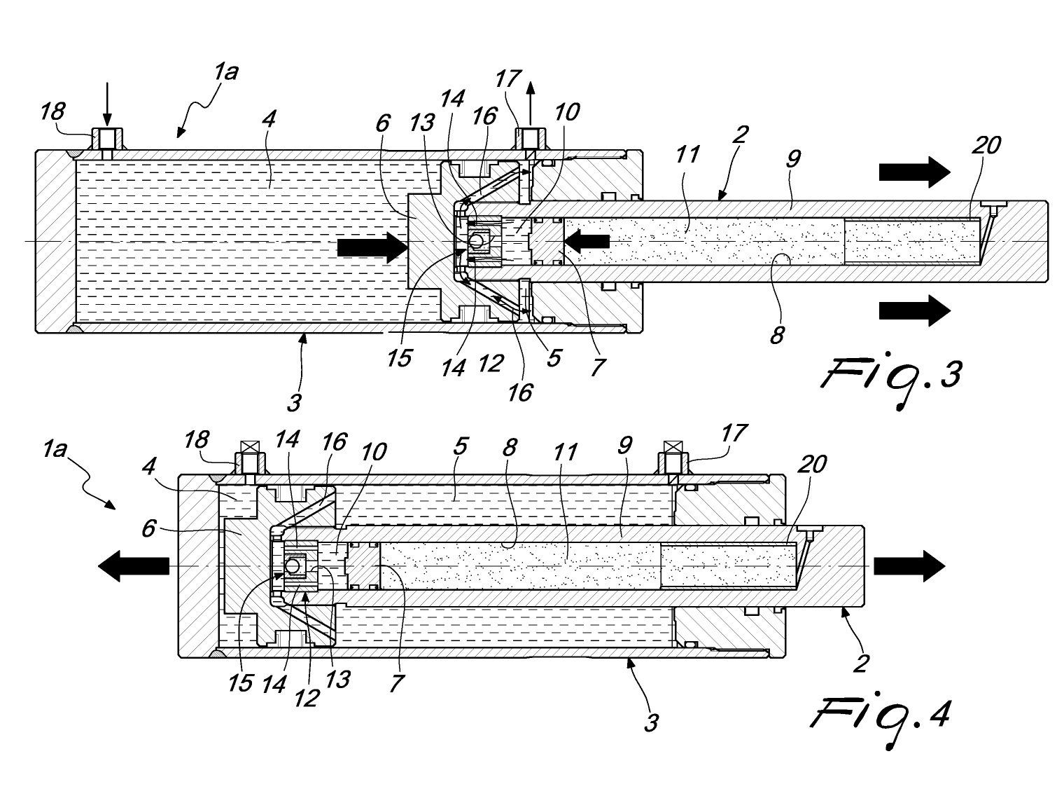

Once the pressure peak has ceased, as shown in FIG. 3, the second fluid undergoes an expansion, recovering the initial volume and making the first fluid flow out from the first portion 10 to the chamber 5 exclusively through the secondary connecting channels 14, since the main connecting channel 13 remains closed.

In this manner, the outflow rate is lower than what occurred previously, allowing the hydraulic actuator 1a to react to the hammer in a damped manner.

With reference to FIGS. 4 to 6, again in the first embodiment proposed, a hydraulic actuator 1a for protecting extension is shown.

In normal operating conditions, the hydraulic actuator 1a shown in FIG. 4 has the delivery and discharge ducts 17 and 18 closed by means of an adapted safety valve, which is indicated symbolically for the sake of graphic simplicity by a square with an X.

In this manner, the first fluid is locked in both directions and the piston 2 remains ideally in position in the hollow cylinder 3 by way of the pressure applied by the first pressurized fluid in the chambers 4 and 5.

In this configuration, the first fluid that is present in the chamber 5, which is connected to the first portion 10 of the longitudinal cavity 8 by means of the ducts 16 defined inside the head 6 of the piston 2, is in equilibrium with the second fluid that is present in the second portion 11 of the longitudinal cavity 8 by means of the first movable element 7, filtering through the secondary connecting channels 14.

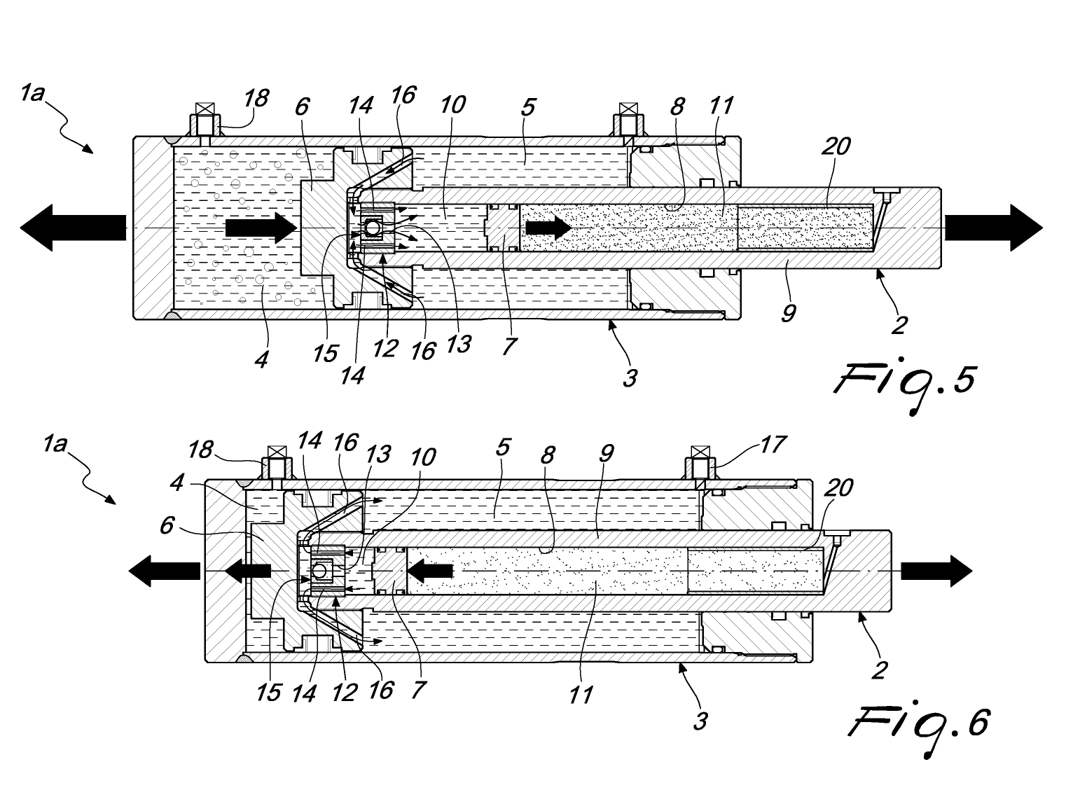

In case of a sudden overload in extension, as shown in FIG. 5, an overpressure is generated in the chamber 5 that is defined around the stem 9 of the piston 2 and, when it becomes greater than the pressure of the second fluid contained in the second portion 11 of the longitudinal cavity 9, leads to the temporary opening of the one-way valve 15, causing the first fluid to filter through the primary connecting channel 13, which leads to the movement of the first movable element 7, which compresses the second fluid that is present in the second portion 11 until a new condition of equilibrium is reached.

In this manner, the second fluid yields volume, allowing the shock absorbing extension movement of the hydraulic actuator 1a.

Simultaneously, the first fluid that is present in the chamber 4 assumes a negative pressure, possibly bringing such fluid to cavitation, as shown by the bubbles illustrated in FIG. 5.

Since this is hydraulic oil, this phenomenon may not lead to structurally damage to the hydraulic actuator 1a, but if the internal walls of the hollow cylinder 3 and the outer walls of the piston 2 suffer damage, there may be a gas compensation buffer connected to the chamber 4 so as to prevent the first fluid from entering cavitation, since such gas can expand in case of pressure decreases.

Once the overload condition is over, as shown in FIG. 6, the second fluid resumes expanding and the first fluid slowly flows out exclusively through the secondary connecting channels 14, since the one-way valve 15 has returned to its inactive condition, closing the main connecting channel 13.

In this manner, a return of the piston 2 to its working position occurs with a damped speed.

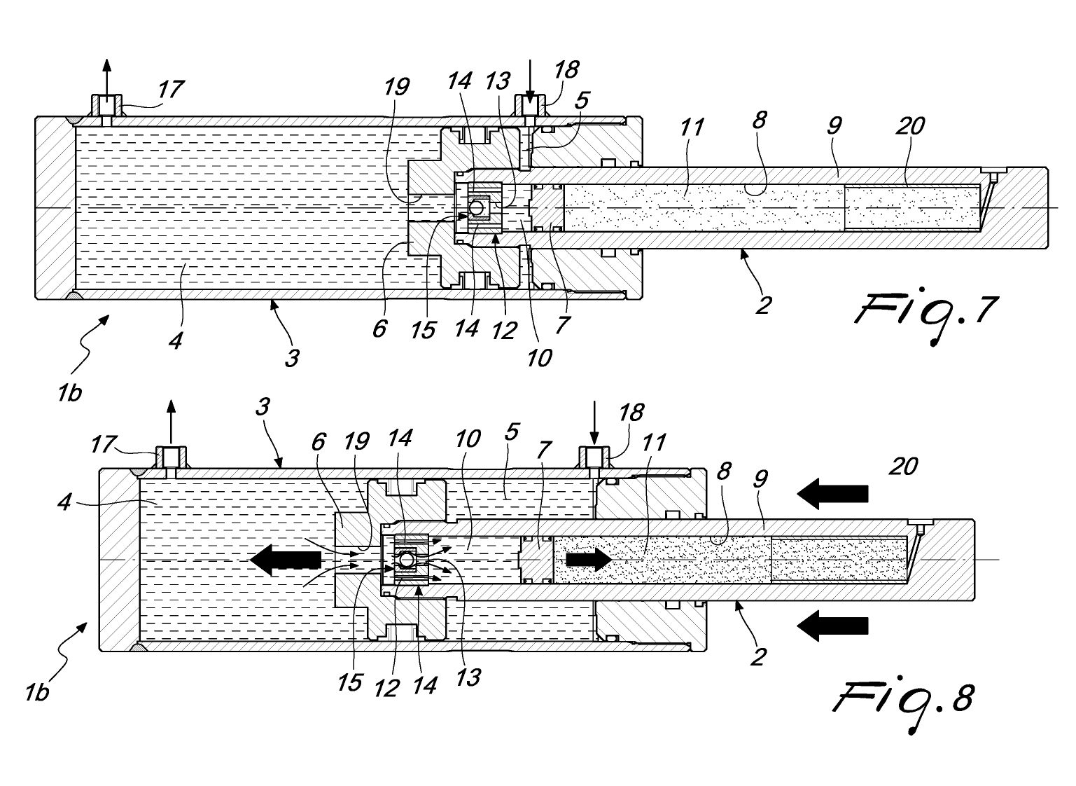

With reference to FIGS. 7 to 9, a hydraulic actuator 1b that acts by compression is shown in the second proposed embodiment.

Starting from a position in which the piston 2 is fully extracted from the hollow cylinder 3, shown in FIG. 7, the external circuit for delivery of the first fluid feeds the chamber 5, emptying the chamber 5 in order to make the piston 2 retract.

Due to the inertias of the system, in this initial transient situation a pressure peak can occur such that the pressure of the first fluid exceeds its nominal value, leading to the phenomenon commonly known as hammer.

If this overpressure is such as to exceed also the value of the nominal pressure of the second fluid contained in the second portion 11 of the longitudinal cavity 8 provided internally in the stem 9 of the piston 2, the one-way valve 15 opens, causing the rapid outflow of the first fluid into the first portion 10 of the longitudinal cavity 8, with corresponding movement of the first movable element 7 and consequent compression of the second fluid, as shown in FIG. 8.

This flow of the first fluid from the chamber 5 into the first portion 10, which occurs by means of one or more ducts 19 defined inside the head 6 of the piston 2, continues until a new condition of equilibrium between the two fluids has been reached.

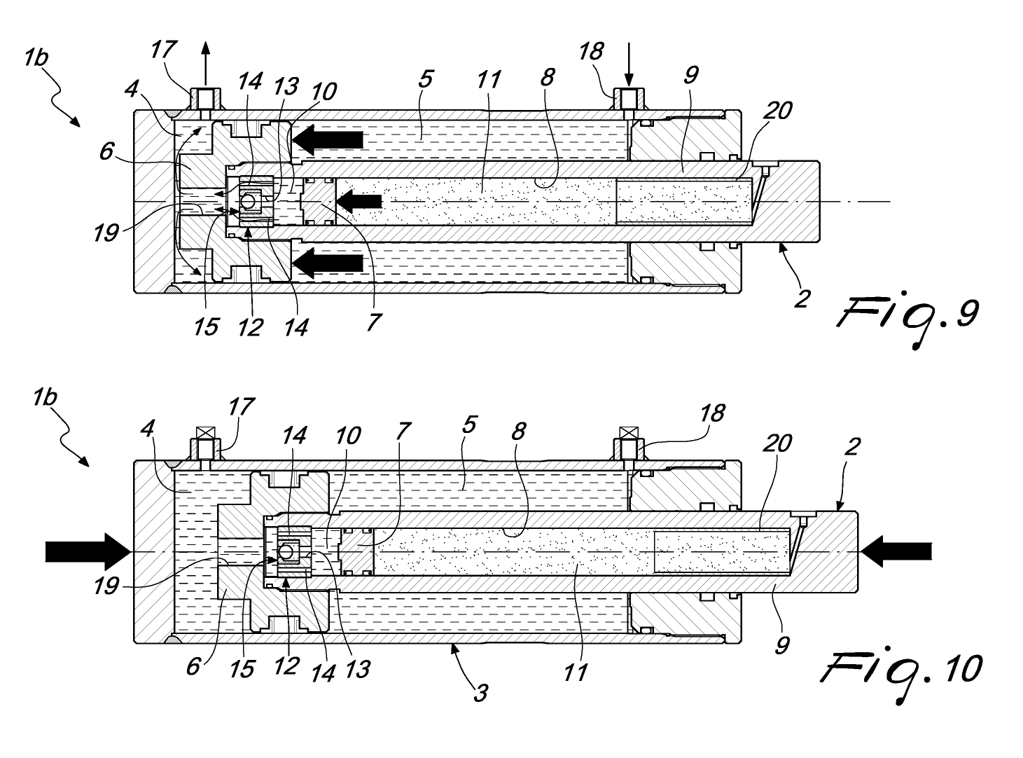

Once the pressure peak has ceased, as shown in FIG. 9, the second fluid undergoes an expansion, recovering the initial volume and causing the outflow of the first fluid from the first portion 10 to the chamber 4 through the secondary connecting channels 14 alone, since the main connecting channel 1413 remains closed.

In this manner, the outflow rate is lower than what occurred previously, allowing the hydraulic actuator 1b to react to the hammer in a damped manner.

With reference to FIGS. 10 to 12, a hydraulic actuator 1b to protect compression is shown again in the second proposed embodiment.

In normal operating conditions, the hydraulic actuator 1b shown in FIG. 10 has the discharge and delivery ducts 17 and 18 closed by means of an adapted safety valve, indicated symbolically, for the sake of graphical simplicity, by a square with an X.

In this manner, the first fluid is blocked in both directions and the piston 2 remains ideally in position in the hollow cylinder 3 by way of the pressure applied by the first pressurized fluid in the chambers 4 and 5.

In this configuration, the first fluid that is present in the chamber 4, which is connected to the first portion 10 of the longitudinal cavity 8 by means of the duct 19 defined inside the head 6 of the piston 2, is in equilibrium with the second fluid that is present in the second portion 11 of the longitudinal cavity 8 by means of the first movable element 7 by filtering through the secondary connecting channels 14.

In case of sudden overload in extension, as shown in FIG. 11, an overpressure is generated in the chamber 5 that is defined around the stem 9 of the piston 2 and, when it becomes greater than the pressure of the second fluid contained in the second portion 11 of the longitudinal cavity 8, leads to the temporary opening of the one-way valve 15, causing the first fluid to filter through the primary connecting channel 13, and this leads to the displacement of the first movable element 7, which compresses the second fluid that is present in the second portion 11 until it reaches a new equilibrium condition.

In this manner, the second fluid yields volume, allowing the damped movement in compression of the hydraulic actuator 1b.

At the same time, the first fluid that is present in the chamber 5 assumes a negative pressure, possibly bringing such fluid to cavitation, as shown by the bubbles illustrated in FIG. 11.

Since this is hydraulic oil, this phenomenon may not lead to structural damage to the hydraulic actuator 1b, but if the internal walls of the hollow cylinder 3 and the outer walls of the piston 2 are damaged there can be a gas compensation buffer that is connected to the chamber 5 so as to prevent the first fluid from cavitating, such gas being able to expand in case of pressure decreases.

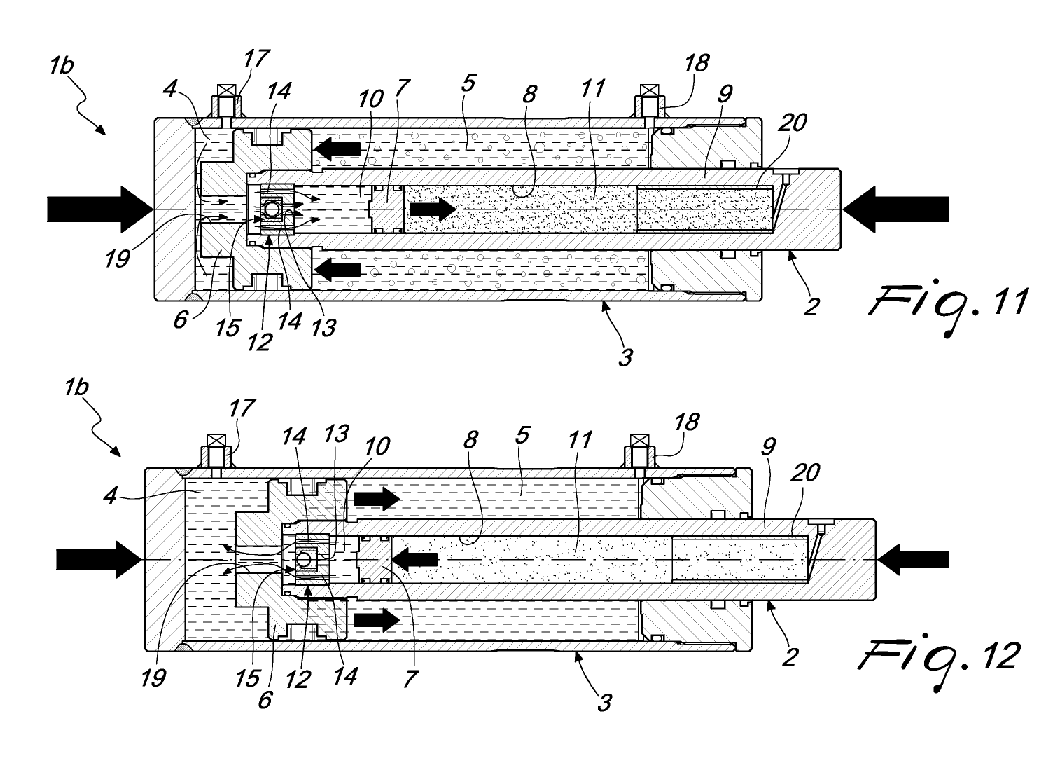

Once the overload condition has passed, as shown in FIG. 12, the second fluid resumes expanding and the first fluid flows out slowly exclusively through the secondary connecting channels 14, since the one-way valve 15 has returned to its inactive condition, closing the main connecting channel 13.

In this manner, a return at a damped rate of the piston 2 to its working position occurs.

Furthermore, as a completion of the two hydraulic actuators 1a and 1b, there is an element 20 for limiting the stroke of the first movable element 7 arranged in the longitudinal cavity 8 so as to limit the minimum volume in which such second fluid can be compressed.

The operating speed of the actuators 1a and 1b, as well as their rigidity, can be adjusted in different manners.

For example, the passage sections of the first fluid and the volume of the chambers where it is located can be sized so that the piston 2 can move at the desired speeds, utilizing the slowing of the first fluid that flows through the calibrated holes and simultaneously supports the load without undergoing cavitation.

Similarly, by altering the internal pressure of one of the two chambers 4 and 5 with respect to the pressure of the other chamber 4 or 5 and by calibrating differently the passage sections of the delivery and discharge ducts 17 and 18 it is possible to stiffen the effect of the actuator 1a or 1b according to the requirements.

Equally, it is possible to create the play of pressures described above by providing the actuator 1a or 1b with an electric valve at one or both of the delivery and discharge ducts 17 and 18.

In this manner, depending on the extent of the opening of the electric valve, it is possible to increase or decrease the inflow and/or outflow rate of the first fluid in the hydraulic actuator, consequently varying its rigidity in operation.

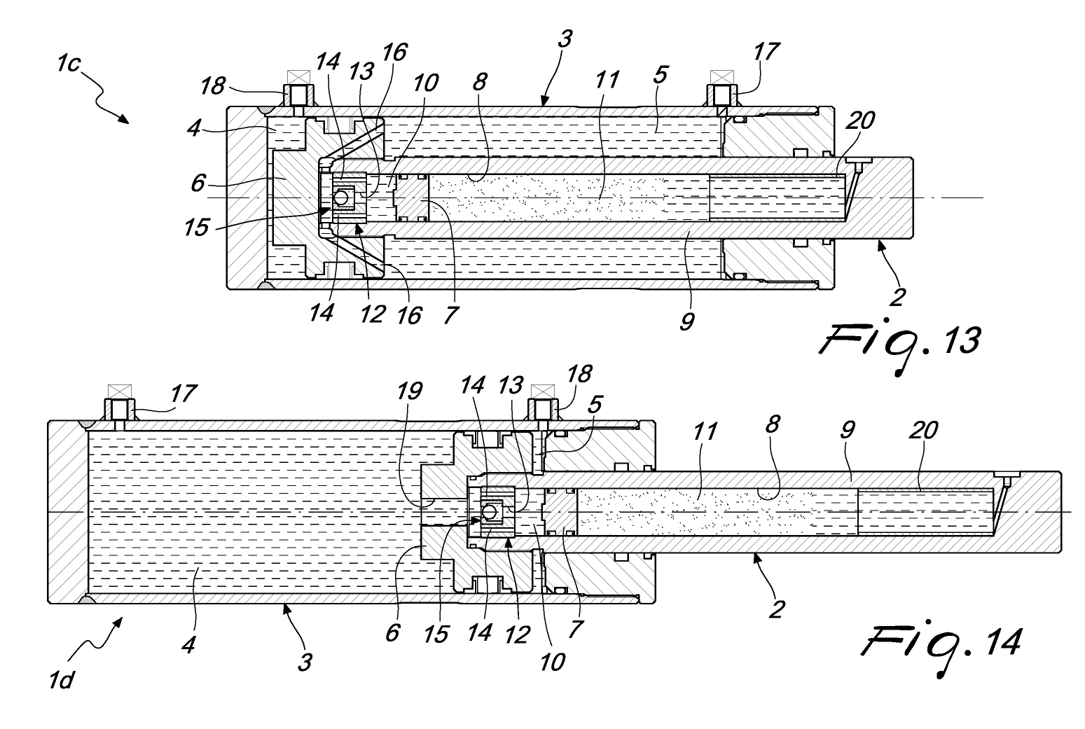

With reference to FIGS. 13 to 16, another way to vary the shock absorbing and/or damping action of the hydraulic actuator may include pumping a third fluid into the second portion 11 with a coefficient of compressibility that is lower than that of the second fluid.

For example, as shown in the variations 1c and 1d of the hydraulic actuators 1a and 1b, the third fluid can be in contact with the second one and be pumped in a calibrated manner into the same second portion 11.

If gas and oil, respectively, are used for the second fluid and the third fluid, the two fluids do not mix, acting independently and in an unaltered manner with respect to each other.

In other words, by increasing the quantity of the third fluid, a more rigid hydraulic actuator 1c or 1d and vice versa is obtained.

If the fluids used might be subjected to chemical reactions once they come into contact, it is possible to provide a second movable element 23, conveniently provided with a valve for the inflow of the second fluid and with a perforated through stem for the loading of gas, which is accommodated slidingly and hermetically in the longitudinal cavity 8 at the second portion 11, so as to divide the second portion 11 into two other portions 24 and 25, in which the first of the two contains the second fluid and the second of the two contains the third fluid.

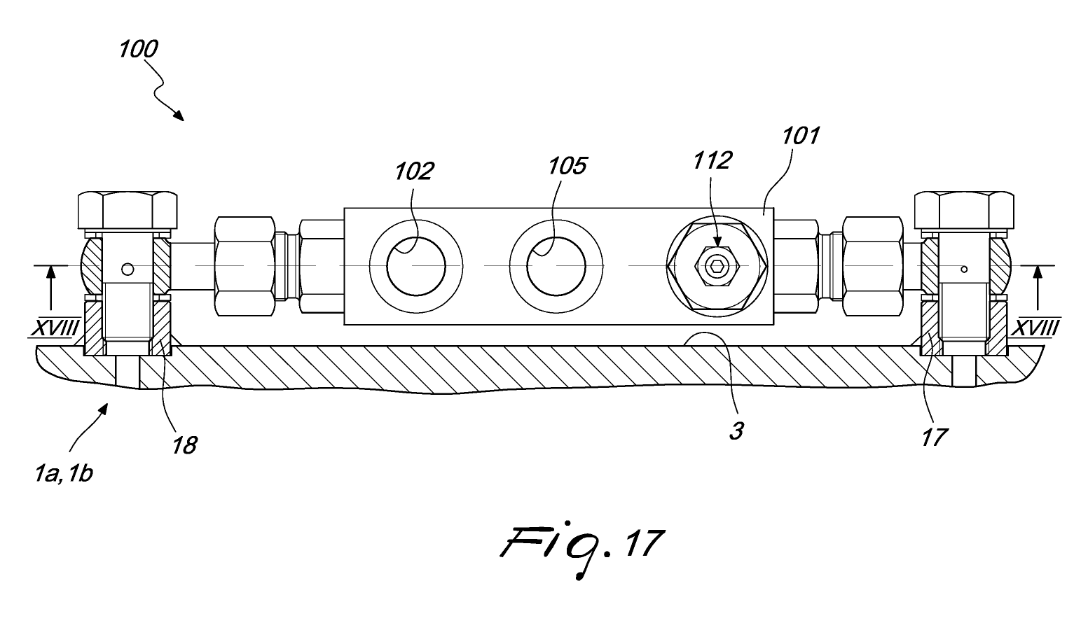

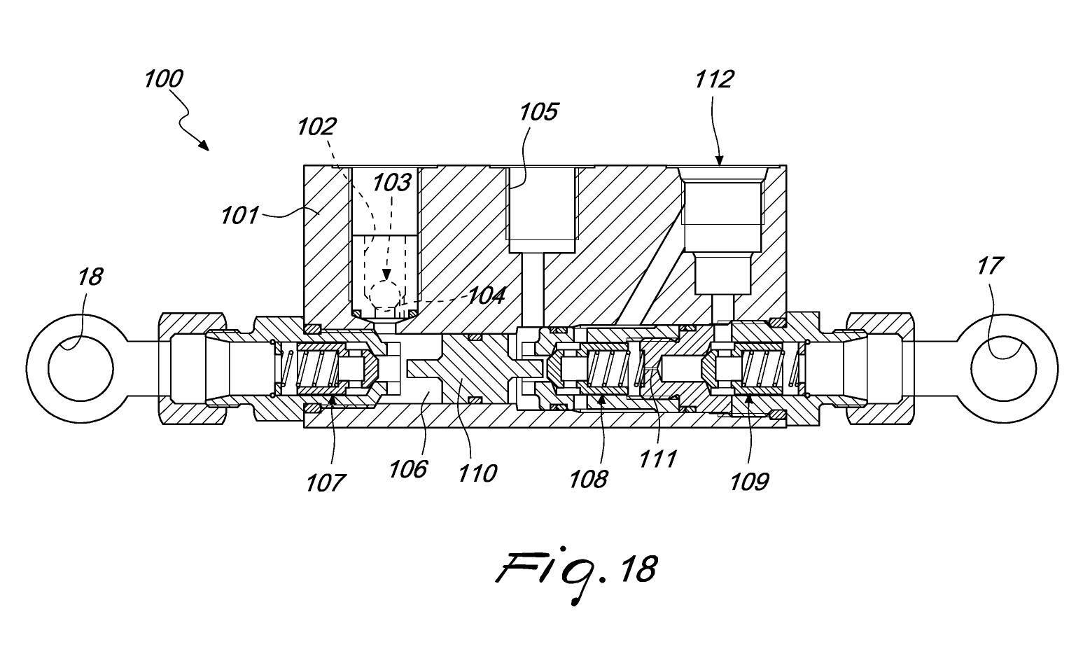

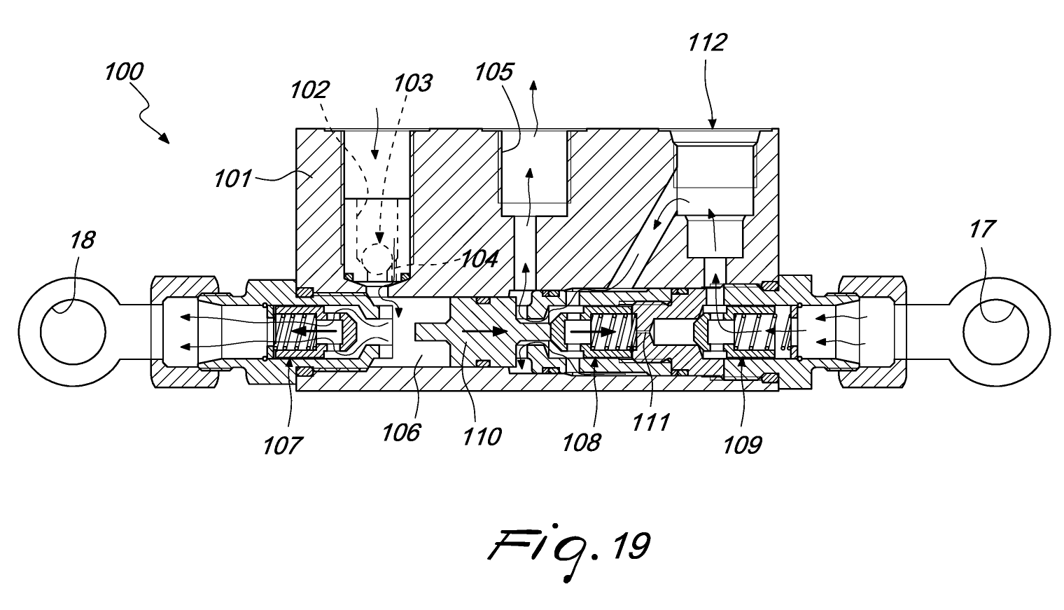

With reference to FIGS. 17 to 20, a further possibility to control and vary the shock absorbing and/or damping action of the hydraulic actuators 1a and 1b includes providing them with at least one safety valve 100 of the double-acting type with limited control on the delivery and a maximum pressure valve on the return which are hydraulically connected to the delivery duct 17 and to the discharge duct 18.

More specifically, as shown in detail in FIG. 18, the safety valve 100 comprises a valve body 101, which defines a first feed or discharge duct 102 provided with a first normally-closed one-way valve 103, for example of the type with a ball that can move in contrast with the action of elastic means, which acts in output to the valve body 102, and with a first calibrated port 104 that is parallel to the first one-way valve 103.

Furthermore, the valve body 101 also defines a second feed or discharge duct 105 that is connected, together with the first feed or discharge duct 102, to a main chamber 106 that is defined inside the valve body 101.

Conveniently, the first feed or discharge duct 102 is connected to the discharge duct 18 the hydraulic actuator 1a or 1b by means of a second normally-closed one-way valve 107, for example of the type with a piston that can move in contrast with the action of elastic means, accommodated within the main chamber 106 and acting in output to the valve body 101 from the first feed or discharge duct 102 toward the discharge duct 18.

Similarly conveniently, the second feed or discharge duct 105 is connected to the delivery duct 17 of the hydraulic actuator 1a or 1b by means of a third normally-closed one-way valve 108 and a fourth normally-closed one-way valve 109, which also are for example of the type with a piston that can move in contrast with the action of elastic means, are accommodated inside the main chamber 106 in sequence with respect to each other and act in output to the valve body 101 from the second feed or discharge 105 toward the delivery duct 17.

Advantageously, between the first feed or discharge duct 102 and the second feed or discharge duct 105 there is a pilot slider 110 of the second one-way valve 107 and of the third one-way valve 108, which is accommodated so that it can slide hermetically in the main chamber 106, so as to actuate selectively the two one-way valves 107 and 108, depending on which of the two feed or discharge ducts 102 and 105 provides the supply.

Finally, between the third one-way valve 108 and the fourth one-way valve 109 there is a second calibrated port 111 and there is further a maximum-pressure valve 112 that is accommodated in the valve body 101 and is connected to the third one-way valve 108 and to the fourth one-way valve 109 so as to bypass the second calibrated port 111 when needed.

With reference to FIG. 19 and FIGS. 4 and 10, by feeding the safety valve 100 through the first feed or discharge duct 102 the first fluid passes at a reduced speed through the first calibrated port 104, creating an overpressure that switches the second one-way valve 107 and moves the pilot slider 110, which switches the third one-way valve 108.

Under load, the piston 2 leads to a gradual pressure increase in the chambers 4 or 5 that is subject to a decrease in volume until the maximum pressure set on the maximum pressure valve 112 is reached, causing the first fluid to flow out directly from the fourth one-way valve 109, switched to the closed state, to the third one-way valve 108, switched to the open state and connected to the second feed or discharge duct 105.

The higher the maximum pressure value is set, the more the effect of hydraulic actuators 1a and 1b is rigid.

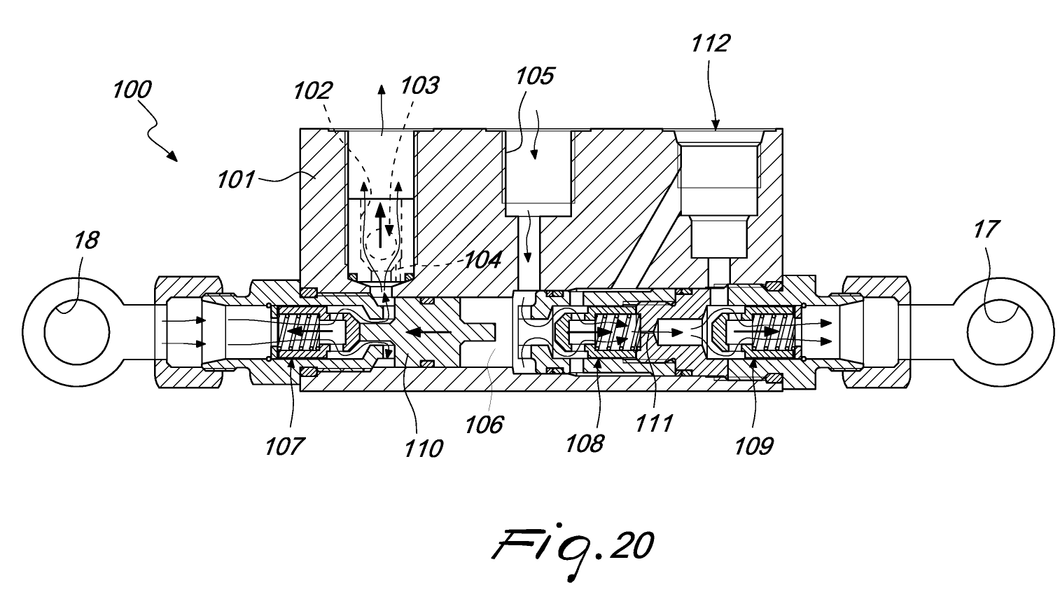

Vice versa, with reference to FIG. 20 and to FIGS. 4 and 10, by supplying the safety valve 100 through the second feed or discharge duct 105 the first fluid opens in sequence the third one-way valve 108 and the fourth one-way valve 109, flowing at a reduced rate through the second calibrated port 111, and moves the pilot slider 110, which switches the second one-way valve 107 and allows the first fluid to flow rapidly through the first feed or discharge duct 105, opening the first one-way valve 103.

In this manner, the piston 2 moves by extension or compression, depending on whether it is the hydraulic actuator 1a or 1b, without altering the pressure of the second fluid contained in the longitudinal cavity 8.

In practice it has been found that the hydraulic actuator, particularly of the shock absorbing and/or damping type, according to the present disclosure, achieves fully the intended aims and advantages, since it allows to act as a shock absorbing and/or damping element, respectively, in response to sudden overloads or pressure peaks (hammer), without entailing an increase in space occupation of any type, giving immediate intervention responses.

In fact, since it contains a minimum quantity of gas, it therefore does not require an external accumulator, gaining both in terms of space occupation and in terms of costs.

In this manner, on-road applications of the actuator according to the disclosure, for example on farming tractors with tools carried in a hanging configuration, lead to great stability of the vehicle, to excellent control and comfort, eliminating jolts and loss of road grip, so as to decrease the risk of losing steering control.

Furthermore, the hydraulic actuator according to the present disclosure obviates the drawbacks noted above regarding the background art, since as the accumulator is provided inside the actuator proper the accumulator is protected by the safety valve, which in case of anomaly prevents any loss of oil, allowing at most only losses of gas pressure.

In this case, a position change of the piston of a few millimeters occurs and then stabilizes, making the actuator work in full safety.

Additionally, the hydraulic actuator according to the present disclosure, by not using external circuits and/or accumulators, is free from load losses that would compromise its operation.

Furthermore, in the case of a plurality of actuators the configuration is independent, since it is possible to modulate its operation by varying the value of the pressure of the second fluid.

Furthermore, another advantage of the hydraulic actuator according to the disclosure resides in that it is possible to vary the internal pressure thereof, altering its operating rigidity according to the operating requirements.

The hydraulic actuator, particularly of the shock absorbing and/or damping type, thus conceived is susceptible of numerous modifications and variations.

Furthermore, all the details may be replaced with other technically equivalent elements.

In practice, the materials used, as well as the contingent shapes and dimensions, may be any according to requirements and to the state of the art.

The disclosures in Italian Patent Application No. 102015000041592 (UB2015A002856) from which this application claims priority are incorporated herein by reference.

1-15. (canceled)

16. A hydraulic actuator comprising a piston that is accommodated so that it can slide hermetically in a hollow cylinder so as to divide the internal volume of said hollow cylinder into two chambers mutually separated by the head of said piston, said two chambers being connectable separately, respectively by means of at least one delivery duct and at least one discharge duct, to a first circuit adapted to feed under pressure a first fluid into one of said two chambers with consequent emptying of the other of said two chambers for the extension or compression movement of said piston with respect to said hollow cylinder, comprising a first movable element that is accommodated so that it can slide hermetically in a longitudinal cavity defined inside the stem of said piston so as to divide said longitudinal cavity into two portions with the first of said two portions connected to one of said two chambers and with the second of said two portions connectable to a second circuit adapted to feed under pressure a second fluid into said second portion, said second fluid having a coefficient of compressibility and a nominal pressure greater than those of said first fluid so as to act as a shock absorber and/or damper in case of sudden peaks of pressure in said chamber connected to said first portion of said longitudinal cavity defined inside said stem of said piston.

17. The hydraulic actuator according to claim 16, further comprising fluid flow control means interposed between said first portion and said chamber connected to said first portion.

18. The hydraulic actuator according to claim 17, wherein said fluid flow control means define a main connecting channel and at least one secondary connecting channel, said main connecting channel having a passage section that has a larger diameter than the passage section of said at least one secondary connecting channel and being provided with a normally-closed one-way valve adapted to prevent the passage of said first fluid from said first portion to said chamber, said at least one secondary connecting channel being free from obstructions.

19. The hydraulic actuator according to claim 18, wherein said one-way valve includes a ball that can move in contrast with the action of elastic means.

20. The hydraulic actuator according to claim 16, wherein said first fluid is oil and said second fluid is gas.

21. The hydraulic actuator according to claim 16, further comprising extension protection.

22. The hydraulic actuator according to claim 21, wherein said head of said piston has at least one duct adapted to connect said first portion to one of said chambers defined around said stem of said piston.

23. The hydraulic actuator according to claim 16, further comprising compression protection.

24. The hydraulic actuator according to claim 23, wherein said head of said piston has at least one duct adapted to connect said first portion to one of said chambers defined at the crown of said head of said piston.

25. The hydraulic actuator according to claim 16, further comprising a stroke limiter of said first movable element arranged in said longitudinal cavity so as to limit the minimum volume in which said second fluid can be compressed.

26. The hydraulic actuator according to claim 16, further comprising a third fluid inside said second portion, said third fluid having a lower coefficient of compressibility than said second fluid, so as to be able to vary the shock absorbing and/or damping action of said hydraulic actuator.

27. The hydraulic actuator according to claim 26, wherein said second fluid and said third fluid are in mutual contact.

28. The hydraulic actuator according to claim 26, further comprising a second movable element that is accommodated so that it can slide hermetically in said longitudinal cavity at said second portion so as to divide said second portion into two other portions, the first one of said two other portions containing said second fluid and the second one of said two other portions containing said third fluid.

29. The hydraulic actuator according to claim 16, further comprising at least one safety valve having limited control on the delivery and a maximum-pressure valve on the return, which are connected hydraulically to said at least one delivery duct and to said at least one discharge duct, so as to be able to vary the shock absorbing and/or damping action of said hydraulic actuator.

30. The hydraulic actuator according to claim 29, wherein said at least one safety valve comprises a valve body that defines a first feed or discharge duct provided with a first normally-closed one-way valve that acts in output to said valve body and with a first calibrated port that is parallel to said first one-way valve and a second feed or discharge duct, which are connected to a main chamber defined inside said valve body, said first feed or discharge duct being connected to said discharge duct by means of a second normally-closed one-way valve which is accommodated inside said main chamber and acts in output to said valve body from said first feed or discharge duct toward said discharge duct, said second feed or discharge duct being connected to said delivery duct by means of a third normally-closed one-way valve and a fourth normally-closed one-way valve, which are accommodated inside said main chamber in sequence to each other and act in output to said valve body from said second feed or discharge duct toward said delivery duct, between said first feed or discharge duct and said second feed or discharge duct there being a pilot slider of said second one-way valve and of said third one-way valve which is accommodated so that it can slide hermetically in said main chamber, between said third one-way valve and said fourth one-way valve there being a second calibrated port and also a maximum-pressure valve accommodated in said valve body and connected to said third one-way valve and to said fourth one-way valve so as to bypass said second calibrated port.
